(19) United States
(12) Patent Application Publication
(10) Pub. No.: US 2018/0306296 A1
(43) Pub. Date: Oct. 25, 2018

(54) POWER TRANSMITTING DEVICE

(71) Applicant: MUSASHI SEIMITSU INDUSTRY CO., LTD., TOYOHASHI-SHI, AICHI (JP)

(72) Inventor: Shohei SAKATA, TOYOHASHI-SHI, AICHI (JP)

(21) Appl. No.: 15/768,307

(22) PCT Filed: Nov. 7, 2016
(86) PCT No.: PCT/JP2016/082977

§ 371 Date: Apr. 13, 2018

(30) Foreign Application Priority Data
Nov. 9, 2015 (JP) 2015-219326

(51) Int. Cl. F16H 48/14; F16H 25/06

(52) U.S. Cl. CPC F16H 48/147; F16H 25/06

(57) ABSTRACT

A power transmitting device includes a first transmission member, an eccentric rotating member, a second transmission member disposed adjacent to the first transmission member, and a transmission mechanism that is provided between the first and second transmission members is formed from a hypotrochoidal first transmission groove and an epitrochoidal second transmission groove formed in one and the other of opposing faces of the first and second transmission members, and a sphere that carries out transmission of torque between the first and second transmission grooves while rolling in the two transmission grooves, wherein the first and second transmission grooves are formed so that each of the transmission grooves and the sphere make contact via two contact points, and a locus of the contact point of each transmission groove having a minimum radius of curvature set to be larger than ½ of a distance between the two contact points of each sphere.

### TECHNICAL FIELD

The present invention relates to a power transmitting device, and in particular to a power transmitting device that includes a first transmission member, an eccentric rotating member that is formed by integrally linking to each other a main shaft portion supported so as to be rotatable around a first axis and an eccentric shaft portion positioned on a second axis eccentric to the first axis, a second transmission member that is disposed adjacent to the first transmission member and is rotatably supported on the eccentric shaft portion, and a transmission mechanism that is provided between the first and second transmission members.

### BACKGROUND ART

An arrangement in which as the power transmitting device a transmission mechanism is for example formed from a hypocycloidal or hypotrochoidal first transmission groove and an epicycloidal or epitrochoidal second transmission groove formed in one and the other of mutually opposing faces of first and second transmission members, and a sphere that carries out transmission of torque between the first and second transmission grooves while rolling in the two transmission grooves is conventionally known as shown in for example Patent Document 1. In this conventional device, the cross-sectional shape of the first and second transmission grooves is a gothic arch shape, and each of the transmission grooves contacts each of the spheres via two contact points.

### RELATED ART DOCUMENTS

### Patent Documents

Patent Document 1: Japanese Patent Application Laid-open No. 2003-172419

### SUMMARY OF THE INVENTION

### Problems to be Solved by the Invention

However, when a conventional power transmitting device as described above is actually produced and operated, it is sometimes the case that the first or second transmission member breaks in the vicinity of a region where the radius of curvature of a bent portion of the transmission groove is a minimum, or the sphere is damaged, and the device attains a state in which transmission is impossible.

The present inventors have investigated the cause thereof and found that, in particular, in a portion of each of the cycloidal or trochoidal transmission grooves where the curvature is large, that is, a bent portion close to the base circle, the sphere makes contact with the transmission groove via three points (e.g. X, Y, and Z in FIG. 7) to thus attain a locked state, which is in no small measure involved in the problem.

The present invention has been accomplished in light of such circumstances, and it is an object thereof to provide a power transmitting device that has a simple structure and can solve the above problems.

### Means for Solving the Problems

In order to attain the above object, according to a first aspect of the present invention, there is provided a power transmitting device comprising a first transmission member, an eccentric rotating member that is formed by integrally linking to each other a main shaft portion supported so as to be rotatable around a first axis and an eccentric shaft portion positioned on a second axis eccentric to the first axis, a second transmission member that is disposed adjacent to the first transmission member and is rotatably supported on the eccentric shaft portion, and a transmission mechanism that is provided between the first and second transmission members, the transmission mechanism being formed from a hypotrochoidal first transmission groove and an epitrochoidal second transmission groove that are formed in one and the other of opposing faces of the first and second transmission members and a sphere that carries out transmission of torque between the first and second transmission grooves while rolling in the two transmission grooves, characterized in that the first and second transmission grooves are formed so that each of the transmission grooves and the sphere make contact via two contact points, and a locus of the contact point on an outer side of a bent portion of each transmission groove has a minimum radius of curvature that is set to be larger than ½ of a distance between the two contact points of each sphere.

Moreover, according to a second aspect of the present invention, in addition to the first aspect, the device further comprises a third transmission member that is disposed adjacent to the second transmission member and is rotatable around the first axis, and a second transmission mechanism provided between the second and third transmission members, the second transmission mechanism being formed from a hypotrochoidal third transmission groove and an epitrochoidal fourth transmission groove that are formed in one and the other of opposing faces of the second and third transmission member, and a second sphere that carries out transmission of torque between the third and fourth transmission grooves while rolling in the two transmission grooves, and the third and fourth transmission grooves being formed so that each of the transmission grooves and the second sphere make contact via two contact points, and a minimum radius of curvature of a locus of the contact point on an outer side of a bent portion of each transmission groove being larger than ½ of a distance between the two contact points of each second sphere.

In the present invention, a ‘bent portion of the transmission groove’ means a bent portion of the transmission groove in a section that is the closest to the base circle of a hypotrochoidal curve for hypotrochoidal first and third transmission grooves and a bent portion of the transmission groove in a section that is the closest to the base circle of an epitrochoidal curve for epitrochoidal second and fourth transmission grooves.

Furthermore, in the present invention, a ‘locus of a contact point on the outer side of the bent portion of the transmission groove’ means a locus, among two contact points, of a contact point on the outer side when viewed from the center in the width direction of the transmission groove, particularly in a bent portion of the transmission groove, that is, on the side further from the center of curvature of the bent portion.

Moreover, in the present invention, ‘being formed so that the transmission groove and the sphere make contact via two contact points’ and ‘being formed so that the transmission groove and the second sphere make contact via two contact points’ includes not only a case in which the transmission groove and the sphere make contact via two contact points without discontinuity throughout the entire region of the transmission groove but also a case in which the transmission groove and the sphere make contact via two contact points over substantially the entire region of the transmission groove but in which there is a region where the transmission groove and the sphere make contact via one point alone because of reasons related to production or design, etc. Furthermore, both of the two contact points may not be involved in power transmission all the time, and power transmission may be carried out by one point alone among the two contact points.

### Effects of the Invention

In accordance with the first aspect of the present invention, since the trochoidal first and second transmission grooves are formed so that each of the transmission grooves and the sphere make contact via two contact points, and a locus of the contact point on the outer side of a bent portion of each transmission groove has a minimum radius of curvature that is set to be larger than ½ of a distance between the two contact points of each sphere, even in a section of each trochoidal transmission groove where the radius of curvature is small, each sphere can efficiently transmit torque between the first and second transmission members while smoothly rolling throughout the entire periphery of each transmission groove. Moreover, since breakage in the vicinity of the bent portion of the transmission groove and damage to the sphere can be avoided effectively, it is possible to contribute to an improvement in the durability of the device.

Furthermore, in accordance with the second aspect of the present invention, since in addition to the transmission mechanism having the first aspect with regard to the shape of the trochoidal first and second transmission grooves, the second transmission mechanism equipped with the trochoidal third and fourth transmission grooves having the same aspect is included, the same effects as above can be achieved with the second transmission mechanism, transmission of torque between the third and fourth transmission members can be carried out efficiently, breakage in the vicinity of the bent portion of the third and fourth transmission grooves and damage to the sphere can be avoided effectively, and it is possible to contribute to an improvement in the durability.

### BRIEF DESCRIPTION OF DRAWINGS

FIG. 1 is a vertical sectional front view of a differential device related to one embodiment of a power transmitting device related to the present invention.

FIG. 2 is an exploded perspective view of an essential part of the differential device.

FIG. 3 is a sectional view from arrowed line 3-3 in FIG. 1.

FIG. 4 is a sectional view from arrowed line 4-4 in FIG. 1.

FIG. 5 is a sectional view from arrowed line 5-5 in FIG. 1.

FIG. 6 (a) is a diagram for explaining and schematically showing the contact point locus of a first transmission ball in a bent portion of a first transmission groove (sectional view along line 6(a)-6(a) in FIG. 1), and FIG. 6 (b) is a diagram for explaining and schematically showing the contact point locus of the first transmission ball in a bent portion of a second transmission groove (sectional view along line 6(b)-6(b) in FIG. 1).

FIG. 7 is a diagram for conceptually explaining a state in which lock of a transmission ball occurs in a bent portion of a transmission groove of a conventional device (diagram corresponding to FIG. 6 (a)).

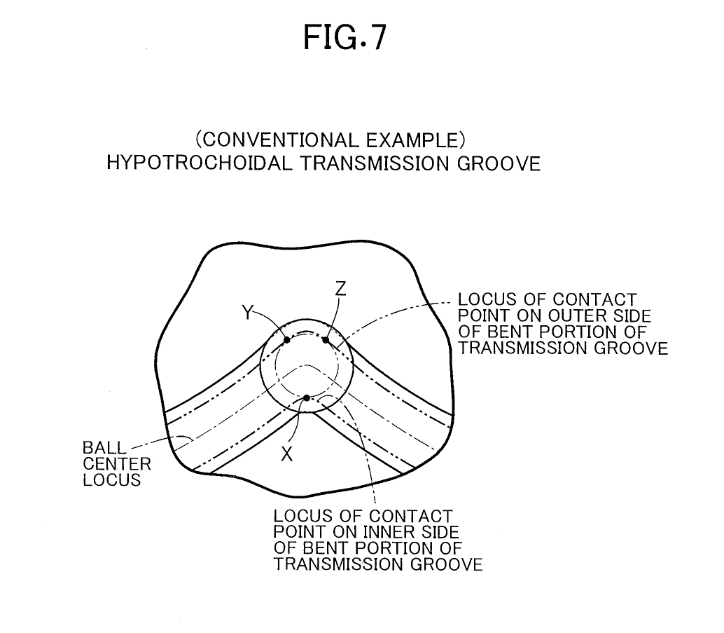

### EXPLANATION OF REFERENCE NUMERALS AND SYMBOLS

A, B; A′, B′ Contact point
C1 First case half body as first transmission member
D Differential device as power transmitting device
P_{B}, P_{B}′ Locus
R, R′ Minimum radius of curvature
T1 First transmission mechanism as transmission mechanism
T2 Second transmission mechanism as second transmission mechanism
X1 First axis
X2 Second axis
d, d′ Distance
6 First output shaft as eccentric rotating member
6j Main shaft portion of first output shaft as eccentric rotating member
6e Eccentric shaft portion of first output shaft as eccentric rotating member
7 Second output shaft as third transmission member
8 Second transmission member
21, 22 First and second transmission grooves
21c, 22c Bent portion of first and second transmission grooves
23 First transmission ball as sphere
24, 25 Third and fourth transmission grooves
24c, 25c Bent portion of third and fourth transmission grooves
26 Second transmission ball as second sphere

### MODES FOR CARRYING OUT THE INVENTION

An embodiment of the present invention is explained below by reference to the attached drawings.

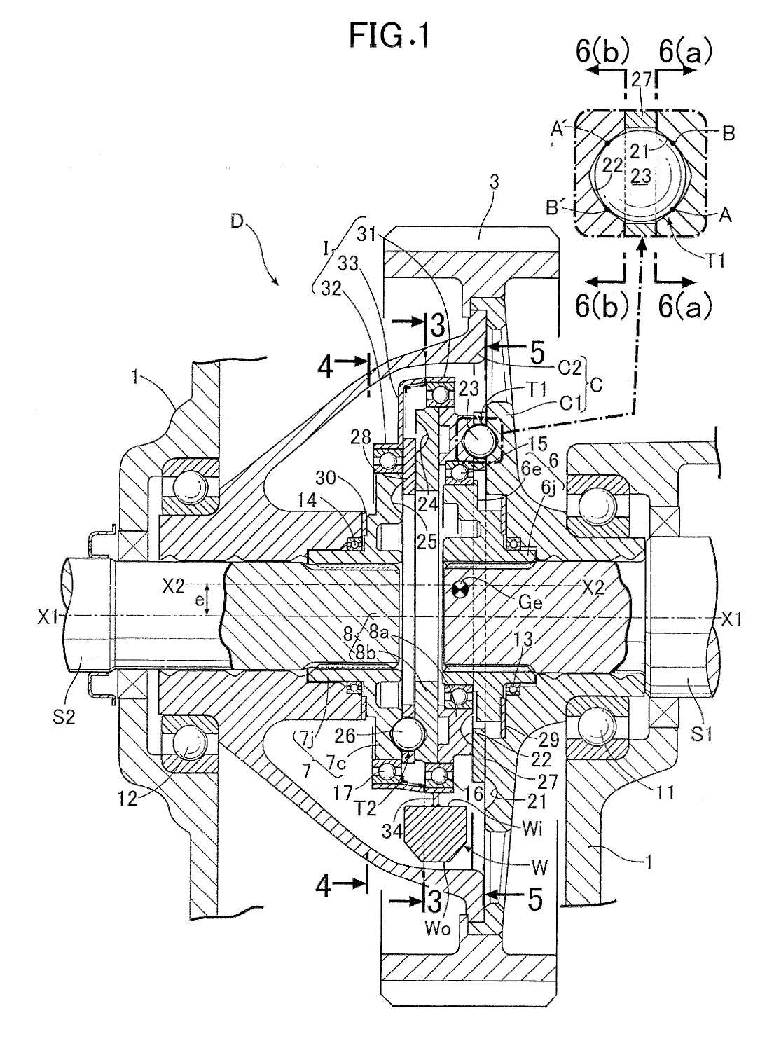

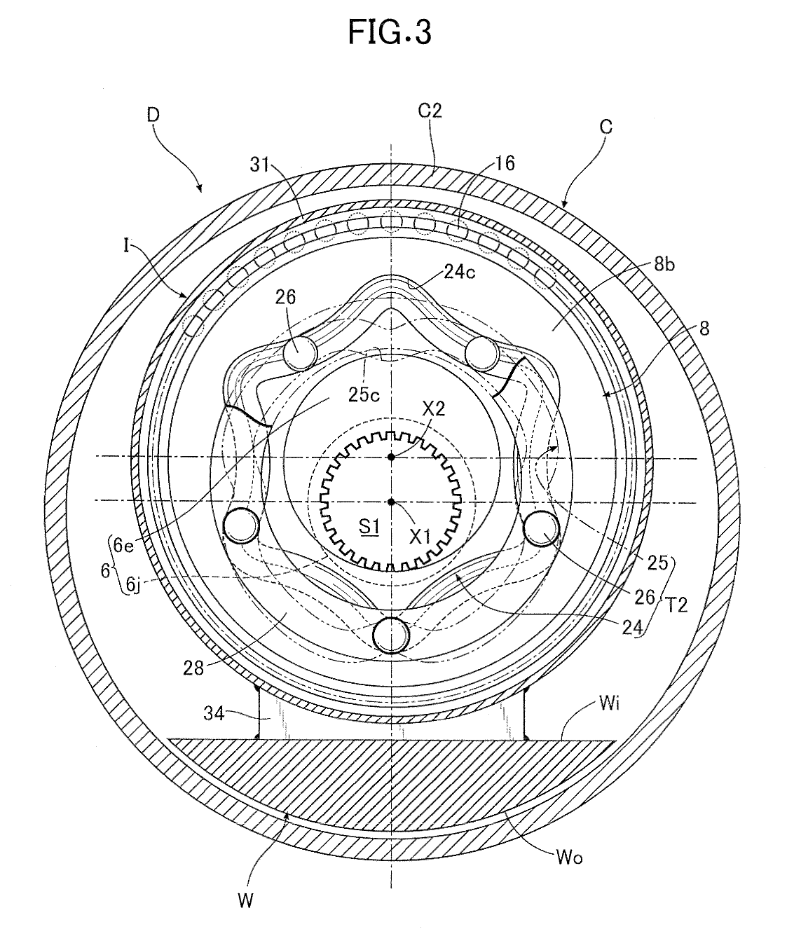

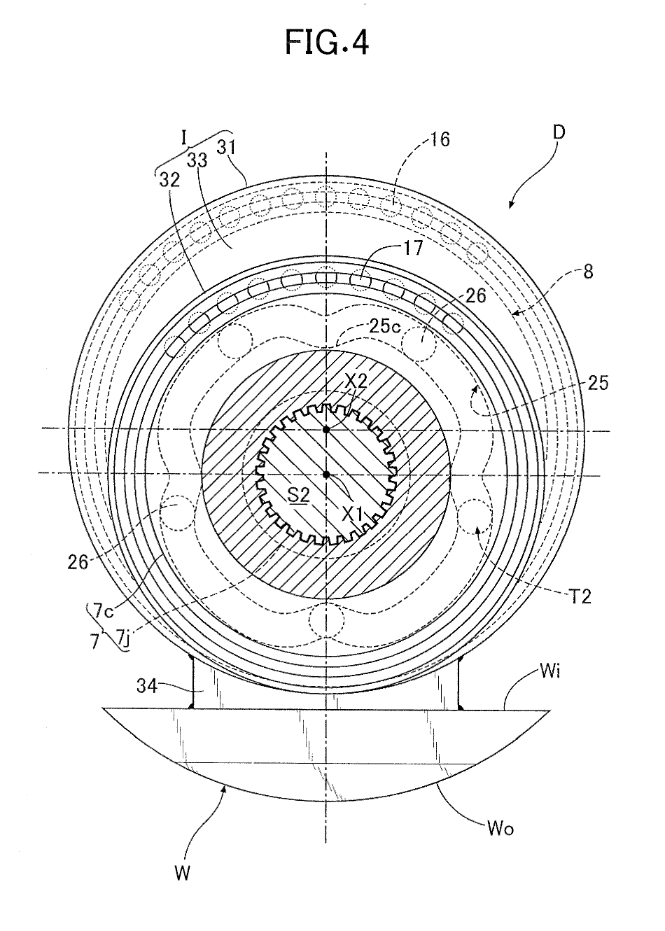

First, one embodiment of the present invention shown in FIG. 1 to FIG. 5 is explained. In FIG. 1, a differential device D is housed within a transmission case 1 of an automobile together with a gear device, the differential device D forming a power transmitting device of the present invention.

The differential device D distributes rotation of a driven gear 3, which is formed from a helical gear rotating in association with the output side of the gear device, between left and right drive axles S1 and S2 relatively rotatably arranged on the central axis of the differential device D, that is, a first axis X1, while allowing differential rotation.

As is clearly shown in FIG. 1, the differential device D includes a differential case C that is rotatably supported on the transmission case 1 via first and second bearings 11 and 12 on the first axis X1. The differential case C is formed from a first case half body C1 and a second case half body C2 joined to the first case half body C1 by welding or bolting.

The second case half body C2 is formed into a bowl shape, and a central boss part of a small diameter end part thereof is rotatably supported on the transmission case 1 via the second bearing 12. On the other hand, the first case half body C1 is formed into a flat shape so as to block a large diameter end face of the second case half body C2, an outer peripheral end part thereof is joined to a large diameter end part of the second case half body C2 by welding or bolting, and a central boss part of the first case half body C1 is rotatably supported on the transmission case 1 via the first bearing 11. The differential case C forms a casing of the present invention, and the first case half body C1 forms a first transmission member of the present invention.

Rotatably supported on the first case half body C1 via a third bearing 13 on the first axis X1 is a first output shaft 6, disposed within the differential case C, of the differential device D, the right drive axle S1 being spline joined to the first output shaft 6. Furthermore, rotatably supported on the second case half body C2 via a fourth bearing 14 on the first axis X1 is a second output shaft 7, disposed within the differential case C, of the differential device D, the left drive axle S2 being spline joined to the second output shaft 7.

The first output shaft 6 is formed by integrally joining a main shaft portion 6j and an eccentric shaft portion 6e, the main shaft portion 6j being rotatably supported via the third bearing 13 on the first axis X1, the right drive axle S1 being spline joined to the main shaft portion 6j, and the eccentric shaft portion 6e being disposed on a second axis X2 eccentric from the first axis X1 only by a constant distance e. The first output shaft 6 forms an eccentric rotating member of the present invention.

Rotatably fitted and supported on the eccentric shaft portion 6e of the first output shaft 6 via a fifth bearing 15 on the second axis X2 is a second transmission member 8 that is disposed within the differential case C (in particular the second case half body C2) and formed into an annular shape with the second axis X2 as a central axis. This enables the second transmission member 8 to revolve around the first axis X1 with respect to the main shaft portion 6j while spinning around the second axis X2 with respect to the eccentric shaft portion 6e of the first output shaft 6 in response to rotation of the first output shaft 6 around the first axis X1.

The second output shaft 7 is formed by integrally joining a main shaft portion 7j and a disk-shaped portion 7c, the main shaft portion 7j being rotatably supported via a fourth bearing 14 on the first axis X1, the left drive axle S2 being spline joined to the main shaft portion 7j, and the disk-shaped portion 7c being coaxially and connectedly provided on an inner end part of the main shaft portion 7j. The second output shaft 7 forms a third transmission member of the present invention.

A first thrust washer 29 and a second thrust washer 30 are relatively rotatably disposed between an inside face of the first case half body C1 and the first output shaft 6 (the eccentric shaft portion 6e) and between an inside face of the second case half body C2 and the second output shaft 7 (the disk-shaped portion 7c) respectively.

In the present embodiment, the second transmission member 8 is formed in a divided manner from a pair of transmission member half bodies 8a and 8b that are adjacent to each other in the axial direction and joined as a unit, the two transmission member half bodies 8a and 8b being integrally joined by appropriate fixing means (e.g. welding, bolting, etc.). One side of the second transmission member 8 (that is, one transmission member half body 8a) adjoins and opposes the inside face of the first case half body C1 as the first transmission member, and the other side of the second transmission member 8 (that is, the other transmission member half body 8b) adjoins and opposes the inside face of the disk-shaped portion 7d of the second output shaft 7 as the third transmission member.

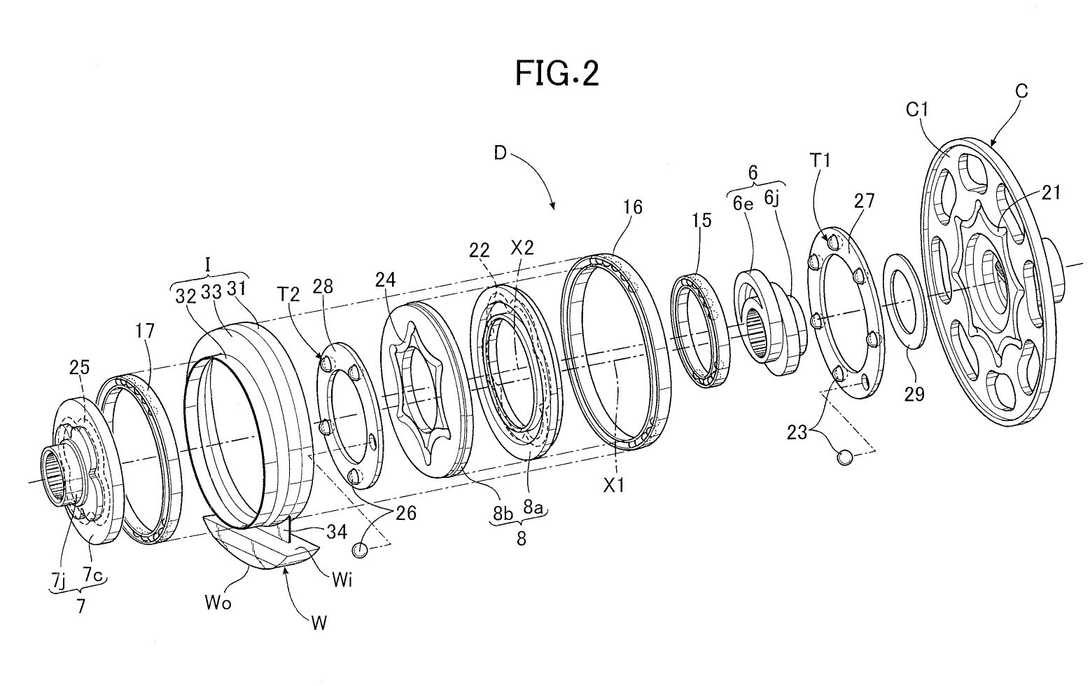

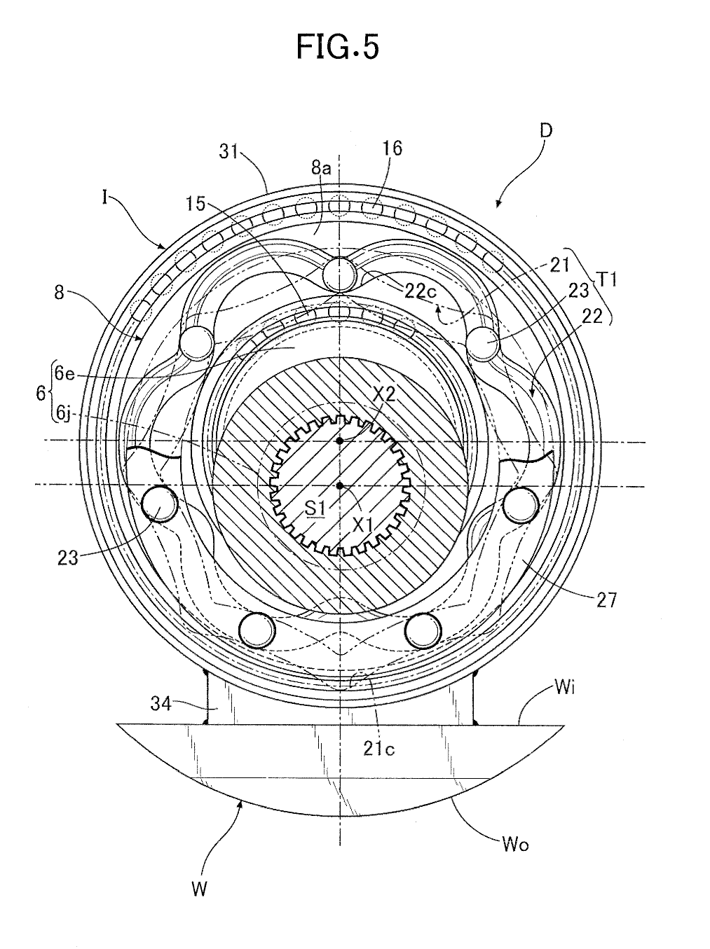

As shown in FIG. 1, FIG. 2, and FIG. 5, formed in the inside face, opposing said one side face of the second transmission member 8 (that is, said one transmission member half body 8a), of the first case half body C1 as the first transmission member is an endless first transmission groove 21 that extends in the peripheral direction along a hypotrochoidal curve having as a base circle a virtual circle having the first axis X1 as a center, and formed in said one side face, opposing the first case half body C1, of the second transmission member 8 is an endless second transmission groove 22 that extends in the peripheral direction along an epitrochoidal curve having as a base circle a virtual circle having the second axis X2 as a center, overlaps the first transmission groove 21 via a plurality of locations, and has a lesser wave number than the wave number of the first transmission groove 21.

The first transmission groove 21 and the second transmission groove 22 are formed so as to have a gothic arch-shaped cross section as is clearly shown in a partial enlarged sectional view of FIG. 1. The gothic arch shape referred to here means a cross-sectional shape in which an inside face part on one side and an inside face part on the other side of each of the transmission grooves 21 and 22 are formed so as to have an arc-shaped cross section and the two inside face parts are connected to each other in a groove bottom part via an edge part or a connecting part that has a larger curvature than the inside face part. In the illustrated example, the cross-sectional shape of the inside face part of each of the transmission grooves 21 and 22 is an arc shape that is curved so as to protrude toward the outside of the transmission grooves 21 and 22, but may be an arc shape that is curved so as to protrude toward the inside.

A plurality of first transmission balls 23 as spheres are disposed in parts where the first transmission groove 21 and the second transmission groove 22 overlap each other, each first transmission ball 23 being capable of rolling on each of the two inside faces of the transmission grooves 21 and 22. The plurality of first transmission balls 23 are retained at positions at equal intervals on the same circumference by means of an annular first race plate 27.

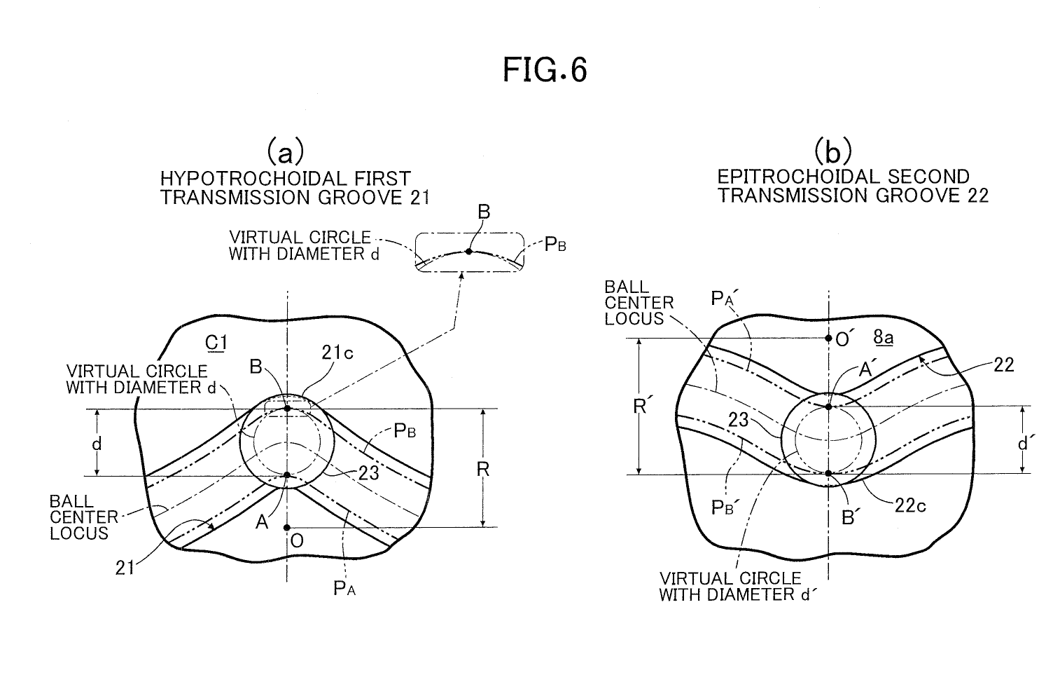

Each first transmission ball 23 contacts the first and second transmission grooves 21 and 22 having the gothic arch-shaped cross section via two contact points A, B; A′, B′ respectively. Contact point loci P_{A}, P_{B}; P_{A}′, P_{B}′ of the two contact points A, B; A′, B′ can be illustrated for example as shown in FIG. 6 (a) for the contact point locus P_{A} on the first transmission groove 21 side and as shown in FIG. 6 (b) for the contact point locus P_{B} on the second transmission groove 22 side.

In the present embodiment, in particular, a minimum radius of curvature R of the contact point locus P_{B} of the contact point B on the outer side of the bent portion 21c of the first transmission groove 21 extending in the peripheral direction along a hypotrochoidal curve (that is, further outside in the radial direction of the differential device D than the width direction center line of the first transmission groove 21) is set so as to be larger than ½ of a distance d between the two contact points A and B for the first transmission ball 23 and the first transmission groove 21. In FIG. 6 (a), reference symbol O denotes the center of curvature of the minimum radius of curvature R. On the other hand, a minimum radius of curvature R′ of the contact point locus P_{B}′ of the contact point B′ on the outer side of the bent portion 22c of the second transmission groove 22 extending in the peripheral direction along an epitrochoidal curve (that is, further inside in the radial direction of the differential device D than the width direction center line of the second transmission groove 22) is set so as to be larger than ½ of a distance d′ between the two contact points A′ and B′ for the first transmission ball 23 and the second transmission groove 22. In FIG. 6 (b), reference symbol O′ denotes the center of curvature of the minimum radius of curvature R. Furthermore, the distance d between the two contact points A and B for the first transmission ball 23 and the first transmission groove 21 and the distance d′ between the two contact points A′ and B′ for the first transmission ball 23 and the second transmission groove 22 are substantially constant throughout the entire periphery of the groove.

As shown in FIG. 1 to FIG. 4, formed in the other side face of the second transmission member 8 (that is, the other transmission member half body 8b) is an endless third transmission groove 24 extending in the peripheral direction along a hypotrochoidal curve having as a base circle a virtual circle with the second axis X2 as a center, and formed in a face, opposing the second transmission member 8, of the second output shaft 7 as the third transmission member, that is, an inside face of the disk-shaped portion 7c, is an endless fourth transmission groove 25 that extends in the peripheral direction along an epitrochoidal curve having as a base circle a virtual circle with the first axis X1 as a center, overlaps the third transmission groove 24 via a plurality of locations, and has a lesser wave number than the wave number of the third transmission groove 24. The third transmission groove 24 and the fourth transmission groove 25 are also formed with a gothic arch-shaped cross section as for the first and second transmission grooves 21 and 22.

A plurality of second transmission balls 26 are disposed as second spheres in parts where the third transmission groove 24 and the fourth transmission groove 25 overlap each other, each second transmission ball 26 being capable of rolling on inside faces of the transmission grooves 24 and 25. The plurality of second transmission balls 26 are retained at positions at equal intervals on the same circumference by means of an annular second race plate 28.

Each second transmission ball 26 contacts each of the third and fourth transmission grooves 24 and 25 formed so as to have a gothic arch-shaped cross section via two points, and the locus of the two contact points is also set in the same manner as for the contact point locus P_{A}, P_{B}; P_{A}′, P_{B}′ for the first transmission ball 23 and the first and second transmission grooves 21 and 22. This can be explained as follows (illustration omitted) using the reference numerals and symbols used when explaining the manner of contact between the first transmission ball 23 and the first and second transmission grooves 21 and 22.

That is, in the present embodiment, in particular, a minimum radius of curvature R of the contact point locus P_{B} of the contact point B on the outer side of a bent portion of the third transmission groove 24 extending in the peripheral direction along a hypotrochoidal curve (that is, further outside in the radial direction of the differential device D than the width direction center line of the third transmission groove 24) is set so as to be larger than ½ of a distance d between the two contact points A and B for the second transmission ball 26 and the third transmission groove 24. On the other hand, a minimum radius of curvature R of the contact point locus P_{B}′ of the contact point B′ on the outer side of a bent portion of the fourth transmission groove 25 extending in the peripheral direction along an epitrochoidal curve (that is, further inside in the radial direction of the differential device D than the width direction center line of the fourth transmission groove 25) is set so as to be larger than ½ of a distance d′ between the two contact points A′ and B′ for the second transmission ball 26 and the fourth transmission groove 25.

The first transmission groove 21 and the fourth transmission groove 25 thus have the first axis X1 as a center, and the second transmission groove 22 and the third transmission groove 24 have the second axis X2 as a center.

In the explanation above, the transmission grooves 21, 22, 24, and 25 are formed so as to satisfy the equation below when the wave number of the first transmission groove 21 is Z1, the wave number of the second transmission groove 22 is Z2, the wave number of the third transmission groove 24 is Z3, and the wave number of the fourth transmission groove 25 is Z4.

(Z1/Z2)×(Z3/Z4)=2

Desirably, as in the illustrated example Z1=8, Z2=6, Z3=6 and Z4=4 or Z1=6, Z2=4, Z3=8 and Z4=6.

In the illustrated example, the first transmission groove 21 having eight waves and the second transmission groove 22 having six waves overlap each other at seven positions, seven first transmission balls 23 being disposed in the seven overlapping parts, and the third transmission groove 24 having six waves and the fourth transmission groove 25 having four waves overlap each other at five positions, five second transmission balls 26 being disposed in the five overlapping parts.

The first transmission groove 21, the second transmission groove 22, and the first transmission ball 23 form in cooperation with each other a first transmission mechanism T1 that can transmit torque between the first case half body C1 (first transmission member) and the second transmission member 8 while changing the speed, and the third transmission groove 24, the fourth transmission groove 25, and the second transmission ball 26 form in cooperation with each other a second transmission mechanism T2 that can transmit torque between the second transmission member 8 and the second output shaft 7 (third transmission member) while changing the speed.

In the present embodiment, the position of a center of gravity Ge of an eccentric rotation system that includes the second transmission member 8 and the eccentric shaft portion 6e of the first output shaft 6 as an eccentric rotating member is displaced at a position spaced from the first axis X1 in a direction toward the second axis X2.

In the differential device D of the present embodiment, in order to eliminate or alleviate an imbalanced state of rotation of the above eccentric rotation system, a balance weight W is specially disposed radially outward of the second transmission member 8 and, moreover, a synchronous rotation mechanism I is provided that makes the balance weight W rotate in synchronism with the eccentric rotating member 6 while retaining the balance weight W at a position with an opposite phase to the eccentric shaft portion 6e with respect to the first axis X1.

The synchronous rotation mechanism I has a large diameter cylindrical first support part 31 supported on the outer periphery of the second transmission member 8 via a sixth bearing 16 so as to be rotatable around the second axis X2, a small diameter cylindrical second support part 32 supported on the second output shaft 7 as the third transmission member via a seventh bearing 17 so as to be rotatable around the first axis X, and an annular linking tubular part 33 as a linking part that integrally links the first and second support parts 31 and 32. The balance weight W is retained on an outer peripheral part of the first support part 31 at a position with an opposite phase to the eccentric shaft portion 6e with respect to the first axis X1.

The operation of the embodiment is now explained.

When, for example, in a state in which the first output shaft 6 (and consequently the eccentric shaft portion 6e) is fixed by fixing the right drive axle S1, the driven gear 3 is driven with power from an engine, and the differential case C, and consequently the first case half body C1, is rotated around the first axis X1, the eight-wave first transmission groove 21 of the first case half body C1 drives the six-wave second transmission groove 22 of the second transmission member 8 via the first transmission ball 23, that is, the first transmission ball 23 rolls on the inside faces of the first and second transmission grooves 21 and 22 while carrying out transmission of torque between the two transmission grooves 21 and 22, and the first case half body C1 therefore drives the second transmission member 8 as the eccentric rotating member with a speed increase ratio of 8/6. In response to this rotation of the second transmission member 8, the six-wave third transmission groove 24 of the second transmission member 8 drives the four-wave fourth transmission groove 25 of the disk-shaped portion 7c of the second output shaft 7 via the second transmission ball 26, that is, the second transmission ball 26 rolls on the inside faces of the third and fourth transmission grooves 24 and 25 while carrying out transmission of torque between the two transmission grooves 24 and 25, and the second transmission member 8 therefore drives the second output shaft 7 with a speed increase ratio of 6/4.

As a result, the first case half body C1 drives the second output shaft 7 with a speed increase ratio of

(Z1/Z2)×(Z3/Z4)=(8/6)×(6/4)=2.

Furthermore, when the first case half body C1 is rotated, in a state in which the second output shaft 7 (and consequently the disk-shaped portion 7c) is fixed by fixing the left drive axle S2, with the rotational driving force of the first case half body C1 and the drive reaction force, relative to the immobile second output shaft 7, of the second transmission member 8, the second transmission member 8 revolves around the first axis X1 while spinning around the eccentric shaft portion 6e of the first output shaft 6, thus driving the eccentric shaft portion 6e around the first axis X1. As a result, the first case half body C1 drives the first output shaft 6 with a speed increase ratio of two times.

If the loads of the first and second output shafts 6 and 7 are balanced or interchanged, the amount of spinning and the amount of revolving of the second transmission member 8 changes steplessly, and the average value for the rotational speed of the two output shafts 6 and 7 becomes equal to the rotational speed of the first case half body C1. Rotation of the first case half body C1 is thus distributed between the first and second output shafts 6 and 7, and the rotational power transmitted from the driven gear 3 to the differential case C can be distributed between the left and right drive axles S1 and S2.

In this arrangement, it becomes possible by satisfying Z1=8, Z2=6, Z3=6 and Z4=4 or Z1=6, Z2=4, Z3=8 and Z4=6 to simplify the structure with the minimum necessary wave number while ensuring a differential function.

In the differential device D, since the rotational torque of the first case half body C1 is transmitted to the second transmission member 8 via the first transmission groove 21, the plurality of first transmission balls 23, and the second transmission groove 22, and the rotational torque of the second transmission member 8 is transmitted to the second output shaft 7 via the third transmission groove 24, the plurality of second transmission balls 26, and the fourth transmission groove 25, transmission of torque between the first case half body C1 and the second transmission member 8 and between the second transmission member 8 and the second output shaft 7 is carried out while being dispersed between the plurality of locations where the first and second transmission balls 23 and 26 are present, and it is possible to enhance the strength and lighten the weight of transmission members such as the first case half body C1 (first transmission member), the second transmission member 8, the second output shaft 7 (third transmission member), and the first and second transmission balls 23 and 26.

Furthermore, during the above process of transmission by the differential device D, the first transmission ball 23 positioned at each of the overlapping parts between the first transmission groove 21 extending in the peripheral direction along a hypotrochoidal curve and the second transmission groove 22 extending in the peripheral direction along an epitrochoidal curve rolls on the inside faces of the transmission grooves 21 and 22 having a gothic arch-shaped cross section while carrying out transmission of torque between the two transmission grooves 21 and 22 while contacting the two transmission grooves 21 and 22 via the two contact points A, B; A′, B′ of each, but there is a possibility that in a section in particular where the curvature of the transmission grooves 21 and 22 is large, that is, the bent portions 21c and 22c close to the base circle, the first transmission ball 23 will contact the transmission grooves 21 and 22 via three points as described above and a locked state will be attained.

As a countermeasure thereagainst, in the present embodiment, the minimum radius of curvature R of the locus P_{B} of the contact point B on the outer side of the bent portion 21c of the first transmission groove 21 extending along a hypotrochoidal curve is set, as shown in FIG. 6 (a), to be larger than ½ of the distance d between the two contact points A and B for the first transmission ball 23 and the first transmission groove 21, and the minimum radius of curvature R of the locus P_{B}′ of the contact point B′ on the outer side of the bent portion 22c of the second transmission groove 22 extending along an epitrochoidal curve is set, as shown in FIG. 6 (b), to be larger than ½ of the distance d′ between the two contact points A′ and B′ for the first transmission ball 23 and the second transmission groove 22. This enables each of the first transmission balls 23 to efficiently carry out transmission of torque between the first case half body C1 (first transmission member) and the second transmission member 8 even in the trochoidal first and second transmission grooves 21 and 22, and in particular the section where the radius of curvature is small (that is, the bent portions 21c and 22c), while smoothly rolling throughout the entire periphery of the transmission grooves 21 and 22. Moreover, since breakage in the vicinity of the bent portions 21c and 22c of the transmission grooves 21 and 22 and damage to the first transmission ball 23 can be avoided effectively, the first transmission mechanism T1, and consequently the differential device D, have enhanced durability.

On the other hand, in the second transmission mechanism T2, each second transmission ball 26 contacts the third and fourth transmission grooves 24 and 25 formed so as to have a gothic arch-shaped cross section via two points, and the loci of the two contact points are set in the same manner as for the contact point loci P_{A}, P_{B}; P_{A}′, P_{B}′ of the first transmission ball 23 with respect to the first and second transmission grooves 21 and 22 as described above. The same operational effects as those of the first transmission mechanism T1 can thereby be anticipated for the second transmission mechanism T2. That is, in the trochoidal third and fourth transmission grooves 24 and 25, in particular even in the section where the radius of curvature is small (i.e. the bent portions 24c and 25c), each second transmission ball 26 can efficiently carry out transmission of torque between the second transmission member 8 and the second output shaft 7 (third transmission member) while smoothly rolling throughout the entire periphery of each of the transmission grooves 24 and 25. Moreover, since breakage in the vicinity of the bent portions 24c and 25c of the transmission grooves 24 and 25 and damage to the second transmission ball 26 can be avoided effectively, the durability of the second transmission mechanism T2 can be enhanced.

An embodiment of the present invention is explained above, but the present invention may be modified in a variety of ways as long as the modifications do not depart from the spirit and scope thereof.

For example, in the embodiment, the differential device D is illustrated as the power transmitting device, the differential device D carrying out distribution from the differential case C (casing), which receives power from a power source, between the first output shaft 6 (eccentric rotating member) and the second output shaft 7 (third transmission member) via the second transmission member 8 and the first and second transmission mechanisms T1 and T2 while allowing differential rotation, but the present invention can be applied to various types of power transmitting devices other than a differential device. For example, the differential device D of the embodiment can be converted to a transmission (a reduction gear or a speed-increasing gear) by defining a casing corresponding to the differential case C of the embodiment as a fixed transmission case, defining either one of the first output shaft 6 (eccentric rotating member) and the second output shaft 7 (third transmission member) as an input shaft, and defining the other thereof as an output shaft, the rotational torque inputted into the input shaft being changed in speed (decreased in speed or increased in speed) and transmitted to the output shaft, and in this case the transmission (the reduction gear or the speed-increasing gear) is considered to be the power transmitting device of the present invention.

Furthermore, in the embodiment, the differential device D as a power transmitting device is housed within an automobile transmission case M, but the differential device D is not limited to a differential device for an automobile and may be applied to a differential device for various types of machines and devices.

Moreover, in the embodiment, a case is illustrated in which the differential device D as a power transmitting device is applied to a left and right wheel transmission system, and distributes the power between the left and right drive axles S1 and S2 while allowing differential rotation, but in the present invention a differential device as a power transmitting device may be applied to a front and rear wheel transmission system in a front and rear wheel drive vehicle, and the power may be distributed between the front and rear driven wheels while allowing differential rotation.

Furthermore, in the embodiment, a case is illustrated in which the second transmission mechanism T2 is the same rolling ball type transmission mechanism as the first transmission mechanism T1, but the second transmission mechanism is not limited to the structure of the embodiment. That is, various types of transmission mechanisms including a transmission member (that is, second transmission members) that enables spinning around a second axis and revolving around a first axis in association with rotation of an eccentric rotating member, for example, an internal planetary gear mechanism and a cycloidal reduction gear (speed-increasing gear) or a trochoidal reduction gear (speed-increasing gear) with various types of structures can be embodied as the second transmission mechanism.

Moreover, in the embodiment, the second transmission member 8 is formed in a divided manner from the pair of transmission member half bodies 8a and 8b and the two transmission member half bodies 8a and 8b are integrally joined to each other, but in the present invention a single body may be used as a second transmission member.

Furthermore, in the embodiment, the cross-sectional shape of each of the transmission grooves 21, 22, 24, and 25 is a gothic arch, but the transmission groove of the present invention is not limited to one having the cross-sectional shape of the embodiment, and another cross-sectional shape that enables the transmission balls 23, 26 as spheres to contact via two points, for example a V-shaped cross section may be employed.

1. A power transmitting device comprising
a first transmission member,
an eccentric rotating member that is formed by integrally linking to each other a main shaft portion supported so as to be rotatable around a first axis and an eccentric shaft portion positioned on a second axis eccentric to the first axis,
a second transmission member that is disposed adjacent to the first transmission member and is rotatably supported on the eccentric shaft portion, and
a transmission mechanism that is provided between the first and second transmission members,
the transmission mechanism being formed from a hypotrochoidal first transmission groove and an epitrochoidal second transmission groove that are formed in one and the other of opposing faces of the first and second transmission members and a sphere that carries out transmission of torque between the first and second transmission grooves while rolling in the two transmission grooves,
wherein the first and second transmission grooves are formed so that each of the transmission grooves and the sphere make contact via two contact points, and a locus of the contact point on an outer side of a bent portion of each transmission groove has a minimum radius of curvature that is set to be larger than ½ of a distance between the two contact points of each sphere.

2. The power transmitting device according to claim 1, further comprising a third transmission member that is disposed adjacent to the second transmission member and is rotatable around the first axis, and a second transmission mechanism provided between the second and third transmission members,
the second transmission mechanism being formed from a hypotrochoidal third transmission groove and an epitrochoidal fourth transmission groove that are formed in one and the other of opposing faces of the second and third transmission member, and a second sphere that carries out transmission of torque between the third and fourth transmission grooves while rolling in the two transmission grooves, and
the third and fourth transmission grooves being formed so that each of the transmission grooves and the second sphere make contact via two contact points, and a minimum radius of curvature of a locus of the contact point on an outer side of a bent portion of each transmission groove being larger than ½ of a distance between the two contact points of each second sphere.
